(19) United States
(12) Patent Application Publication
(10) Pub. No.: US 2014/0244315 A1
(43) Pub. Date: Aug. 28, 2014

(54) SYSTEMS AND METHODS FOR MANAGING MOBILE DEVICE LIFE CYCLE

(71) Applicant: Brightstar Corp., Miami, FL (US)

(72) Inventors: Donald M. Cahill, Doral, FL (US); Gustavo A. Laredo, Walnut Creek, CA (US)

(73) Assignee: Brightstar Corp., Miami, FL (US)

(21) Appl. No.: 14/188,824

(22) Filed: Feb. 25, 2014

Related U.S. Application Data
(60) Provisional application No. 61/768,864, filed on Feb. 25, 2013.

(51) Int. Cl. G06Q 20/32

(52) U.S. Cl. CPC G06Q 20/322; G06Q 40/08
USPC 705/4

(57) ABSTRACT

A method of managing mobile device lifecycle includes the step of providing a first module in an application residing on a mobile device, whereby upon selection by a user of the mobile device of an insurance purchase transaction, the application initiates a transaction for the purchase of insurance for the mobile device. The method further includes the step of providing a second module in the application residing on the mobile device, whereby upon selection by a user of the mobile device of a sale transaction, the application initiates a transaction for the sale of the mobile device.

### CROSS-REFERENCE

This application claims the benefit of U.S. Provisional Patent Application No. 61/768,864, filed on Feb. 25, 2013, and entitled “Methods and Systems for Managing Mobile Device Lifecycle”, the entire disclosure of which is incorporated herein.

### BACKGROUND

1. Field of the Disclosure

The present disclosure relates to systems and methods for managing mobile device lifecycle and, more particularly, to systems and methods for allowing a user to manage numerous aspects of their mobile device from their mobile device.

2. Description of the Background

Computer-based systems and methods for purchasing mobile device accessories, purchasing mobile device insurance, managing carrier accounts, etc. have been available to consumers for some time. For example, a consumer may use the Internet to log in to their carrier account (e.g., TMobile, AT&T, Sprint, etc.) and manage their account, for example, by changing their plan, upgrading their phone, etc. While a number of Internet websites allow consumers to manage different aspects of their mobile device, each of these Internet websites is independent, limited to the features and functionalities of the website owner (e.g., at a carrier website, only the carrier account can be managed), and the consumer is required to visit multiple websites to manage multiple different aspects of their mobile device. There is an ongoing need and desire to streamline the user mobile device experience.

### SUMMARY

In illustrative embodiments, a method of managing mobile device lifecycle may include the step of providing a first module accessible through an application residing on a mobile device, whereby upon selection by a user of the mobile device of an insurance purchase transaction, the application initiates a transaction for the purchase of insurance for the mobile device. The method may further include the step of providing a second module accessible through the application residing on the mobile device, whereby upon selection by a user of the mobile device of a sale transaction, the application initiates a transaction for the sale of the mobile device.

After initiation of a transaction for the purchase of insurance for a mobile device, the application may perform the steps of retrieving data from the mobile device including a mobile device make and a mobile device model, prompting the user for a state of residence, and reading the state of residence after input by the user. The method may further include the steps of determining, based on the mobile device make and model and user state of residence, whether one or more insurance plans are available for the mobile device and, if one or more insurance plans are available for the mobile device, presenting the available plans on the mobile device and, if no insurance plans are available for the mobile device, indicating that no insurance plans are available and allowing the user of the mobile device to purchase an insurance plan from the mobile device if one or more insurance plans are available.

After initiation of a transaction for the sale of the mobile a, the application may perform the steps of retrieving data from the mobile device including a mobile device make and a mobile device model and retrieving values for the mobile device based on the mobile device make and model. The application may further perform the steps of presenting different values for the mobile device on the mobile device, wherein the values may differ dependent upon a method of payment to the user, collecting personal information from the user, and completing a sale of the mobile device.

A real-time value for a mobile device may be determined by performing the steps of retrieving data from the mobile device including a mobile device make and a mobile device model and assessing a condition of the mobile device by performing the step of prompting the user to enter information about the mobile device or remotely running one or more tests through the application to determine a condition of the mobile device. The step of determining a real-time value for the mobile device may then be performed. The step of remotely running one or more tests may include the steps of prompting the user to move their finger across a screen of the mobile device and sensing whether the movement has an atypical characteristic.

The method of managing mobile device lifecycle may further include the step providing a third module in an application residing on a mobile device, whereby upon selection by a user of the mobile device of a locate or restore operation, the application initiates an operation comprising at least one of the following steps: locating the mobile device by GPS or tower tracking, restoring default settings of the mobile device, and locking at least one function of the mobile device. The step of locking at least one function of the mobile device may be selected from the group consisting of: a full screen lock, a SIM change lock, an SMS lock.

In illustrative embodiments, a computerized system for managing mobile device lifecycle may comprise a mobile device insurance module on a computer configured to provide insurance policy quotes based on a real-time mobile device value and allow a mobile device user to purchase an insurance policy, wherein the insurance module receives data from the mobile device including the mobile device manufacturer and model. The system may further include a mobile device buy-back module on a computer configured to provide a real-time quote for purchase of the mobile device based on a real-time mobile device value and allow a mobile device user to sell their mobile device, wherein the buy-back module receives data from the mobile device including the mobile device manufacturer and model.

The insurance module may be configured to allow a current customer with an insurance policy to view, modify, or cancel their insurance policy. At least one of the insurance and buy-back modules may be configured to assess a condition of a mobile device.

In other illustrative embodiments, a computerized system comprises one or more computing devices including a memory having program code stored therein and a processor in communication with the memory for carrying out instructions in accordance with the stored program code. The program code, when executed by the processor, causes the processor to perform operations comprising allowing selection of an insurance module on a mobile device, wherein the insurance module is configured to allow a mobile device user to purchase insurance utilizing the insurance module and allowing selection of a buy-back module on a mobile device, wherein the buy-back module is configured to allow a mobile device user to access a quote for trade-in their mobile device and allow the mobile device user to trade-in their mobile device.

The operations may comprise, after initiating a transaction for the purchase of insurance, retrieving data from the mobile device including a mobile device make and a mobile device model, prompting the user for a state of residence, and reading the state of residence after input by the user. The operations may further include determining, based on the mobile device make and model and user state of residence, whether one or more insurance plans are available for the mobile device and, if one or more insurance plans are available for the mobile device, presenting the available plans on the mobile device and, if no insurance plans are available for the mobile device, indicating that no insurance plans are available and allowing the user of the mobile device to purchase an insurance plan from the mobile device if one or more insurance plans are available.

The operations may further comprise determining a real-time value for a mobile device by performing the steps of retrieving data from the mobile device including a mobile device make and a mobile device model and assessing a condition of the mobile device by performing at least one of the following steps: prompting the user to enter information about the mobile device and remotely running one or more tests through the application to determine a condition of the mobile device. The step of determining a real-time value for the mobile device may also be performed.

The step of remotely running one or more tests may include the steps of prompting the user to move their finger across a screen of the mobile device and sensing whether the movement has an atypical characteristic.

The operations may further comprise providing a third module in an application residing on a mobile device, whereby upon selection by a user of the mobile device of a locate or restore operation, the application initiates an operation comprising at least one of the following steps: locating the mobile device by GPS or tower tracking, restoring default settings of the mobile device, and locking at least one function of the mobile device.

The step of locking at least one function of the mobile device may be selected from the group consisting of: a full screen lock, a SIM change lock, an SMS lock.

### BRIEF DESCRIPTION OF THE DRAWINGS

FIG. 1A is a diagrammatic view of a system for managing mobile device lifecycle and depicting a plurality of mobile devices that communicate through a wireless network with a plurality of functional modules within a platform;

FIG. 1B is a diagrammatic view of an example mobile device on which various methods of the present disclosure may be initiated;

FIGS. 2A and 2B are architectural diagrams for a buy-back/trade-in module and an insurance module of FIG. 1;

FIG. 3 is a high-level process flow diagram for implementing functionality for various modules of FIG. 1;

FIG. 4 is a screen encountered by a user on their mobile device user interface during a process of determining a value of a mobile device;

FIGS. 5A and 5B are flow diagrams for a process for conducting a trade-in/buy-back, as implemented by the trade-in/buy-back module of FIG. 1;

FIG. 6 is an initial screen encountered by a user on their mobile device user interface during the trade-in/buy-back process of FIGS. 5A and 5B;

FIGS. 7, 8A, 8B, and 9 are screens encountered by a user on their mobile device user interface during the trade-in/buy-back process of FIGS. 5A and 5B;

FIGS. 10A and 10B are flow diagrams for a process for purchasing insurance, as implemented by the insurance module of FIG. 1;

FIGS. 11 and 12 are a home screen and login screen encountered by a user on their mobile device user interface during the insurance purchase process of FIGS. 10A and 10B; and

FIGS. 13-15 are screens encountered by a user on their mobile device user interface during a sale of a mobile device, as implemented by the sale module of FIG. 1.

Other aspects and advantages of the present disclosure will become apparent upon consideration of the following detailed description, wherein similar structures have like or similar reference numerals.

### DETAILED DESCRIPTION

The present disclosure is directed to systems and methods for managing mobile device lifecycle. While the systems and methods of the present disclosure may be embodied in many different forms, several specific embodiments are discussed herein with the understanding that the present disclosure is to be considered only as an exemplification of the principles of the disclosure, and it is not intended to limit the disclosure to the embodiments illustrated.

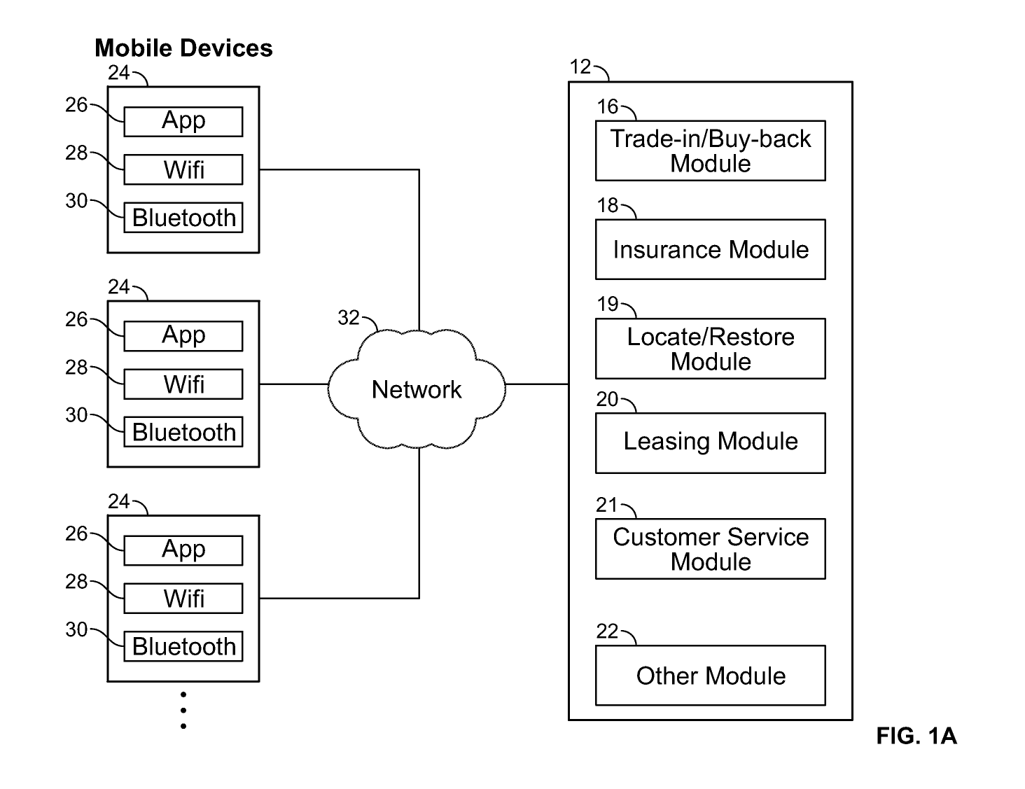

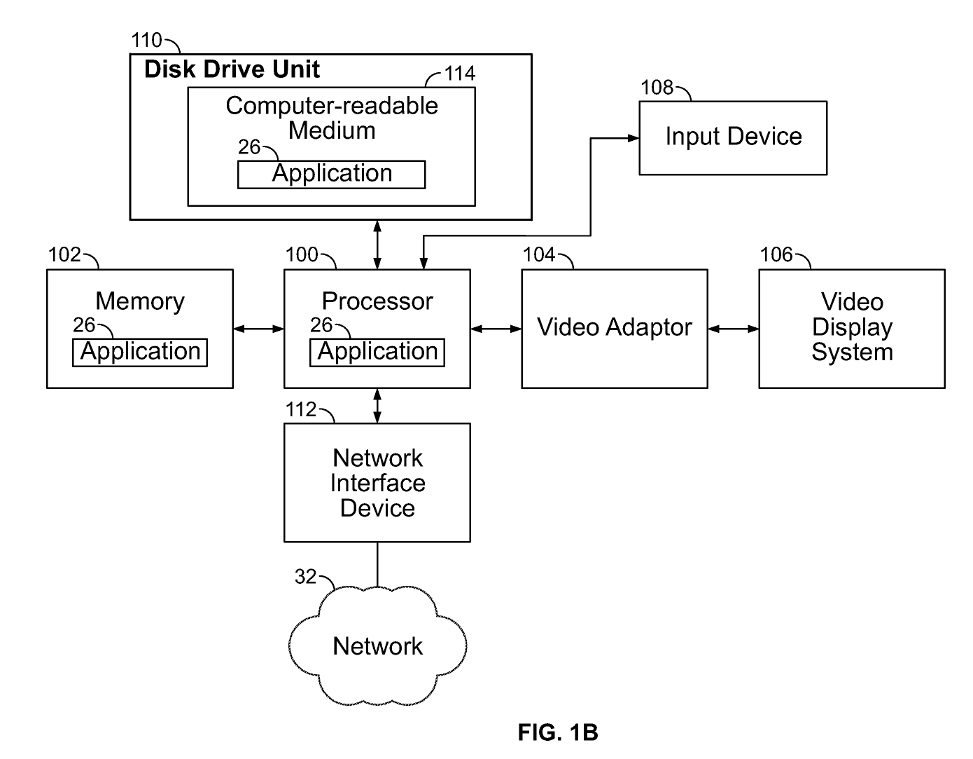

Referring to FIG. 1, a system 10 for managing mobile device lifecycle generally includes a platform 12 in the form of a web server that may include a number of different modules, for example, a trade-in/buy-back module 16 for trade-in/buy-back of a mobile device, an insurance module 18 for purchasing insurance for a mobile device, a location or restoration module for locating and/or restoring a mobile device 19, a leasing or purchasing module 20 for leasing or purchase of a mobile device, a customer service module 21, or any other suitable modules 22. While a number of different modules are discussed herein, one skilled in the art will understand that not all disclosed modules are necessary, additional modules may be utilized, and/or different modules may be utilized.

For the purpose of this specification, the term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

Still referring to FIG. 1, a plurality of mobile devices 24 have downloaded thereon an application 26, as disclosed in greater detail herein, for managing mobile device lifecycle via the modules 16, 18, 19, 20, 21, 22. Each of the mobile devices 24 may be any device capable of executing a set of instructions (sequential or otherwise), for example, a cellular telephone, a tablet, a server, a personal digital assistants (PDSs), a personal computer, a notebook computer, a digital reader, or any other suitable device. The mobile devices 24 for use with the systems and methods herein may run any operating, for example, Blackberry®, Windows®, Android®, iPhone®, or any other suitable operating system.

Each of the mobile devices 24 may be a standalone device or may be connected (e.g., networked) to other mobile devices. In embodiments wherein the mobile device is a standalone device, the set of instructions could be a computer program stored locally on the device that, when executed, causes the device to perform one or more of the methods discussed herein. If, for example, the mobile device 24 is a tablet device, such as an iPad™ or Android™ device, the computer program may be an application 26 installed on the tablet device. In embodiments wherein the computer program is locally stored, data may be retrieved from local storage or from a remote location via a network. For example, some data, such as mobile device type/manufacturer and model may be locally stored, but other data, for example, personal information, may be remotely stored.

The mobile devices 24 depicted in FIG. 1 may generally include a processor 100 (e.g., a central processing unit (CPU)), a memory 102, a video adapter 104 that drives a video display system 106 (e.g., a liquid crystal display (LCD) or a cathode ray tube (CRT)), an input device 108 (e.g., a keyboard, mouse, touch screen display, etc.) for the user to interact with the application 26, a disk drive unit 110, a network interface device 112, and/or any other suitable components. Each of the various mobile devices 24 may not always include all of these peripheral devices.

The disk drive unit 110 includes a computer-readable medium 114 on which is stored one or more sets of computer instructions and data structures embodying or utilized by the application 26 described herein. The computer instructions and data structures may also reside, completely or at least partially, within the memory 102 and/or within the processor 100 during execution thereof by the mobile device 24 accordingly, the memory 102 and the processor 100 also constitute computer-readable media. Embodiments are contemplated in which the application 26 may be transmitted or received over a network 32 via the network interface device 112 utilizing any one of a number of transfer protocols including but not limited to the hypertext transfer protocol (“HTTP”) and file transfer protocol (“FTP”).

The term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing a set of instructions for execution by the machine and that cause the machine to perform any one or more of the methods described herein, or that is capable of storing data structures utilized by or associated with such a set of instructions. The term “computer-readable medium” shall accordingly be taken to include, but not be limited to, solid-state memories, optical media, flash memory, and magnetic media.

The application 26 on each of the mobile devices 24 is in wireless communication with the platform 12 or the individual modules through the network interface device 112 via a wireless communication device of the mobile device 24, such as a WiFi connection 28, a Bluetooth connection 30, or any other suitable wireless communication device. The mobile devices 24 communicate with the platform 12 and the modules 16, 18, 19, 20, 21, 22 within the platform through the network 32. The mobile devices 24 and the modules 16, 18, 19, 20, 21, 22 may be arranged to communicate through the network 32. The network may be any type of communication scheme including, but not limited to, fiber optic, cellular, wired, and/or wireless communication capability in any of a plurality of protocols, such as TCP/IP, Ethernet, WAP, IEEE 802.11, or any other protocol.

As noted above, the platform 12 may include any number of separate, embedded, and/or interconnected modules, which allow a customer or user to manage the lifecycle of their mobile device. In illustrative embodiments, exemplary modules include, but are not limited to, a mobile device buy-back module, an insurance module, a mobile device upgrade module, a mobile device accessory purchase module, a locate/restore module, a user support module, or any other suitable modules that may be utilized to enhance or modify the lifecycle of a mobile device or the user experience with the mobile device and/or their carrier. Other exemplary modules include, but are not limited to, an upgrade module for upgrading a carrier plan or a mobile device, a purchase module for purchasing a new mobile device, and/or a leasing module for leasing a mobile device. While each of the modules is shown as an individual module, any number of the described modules may be combined.

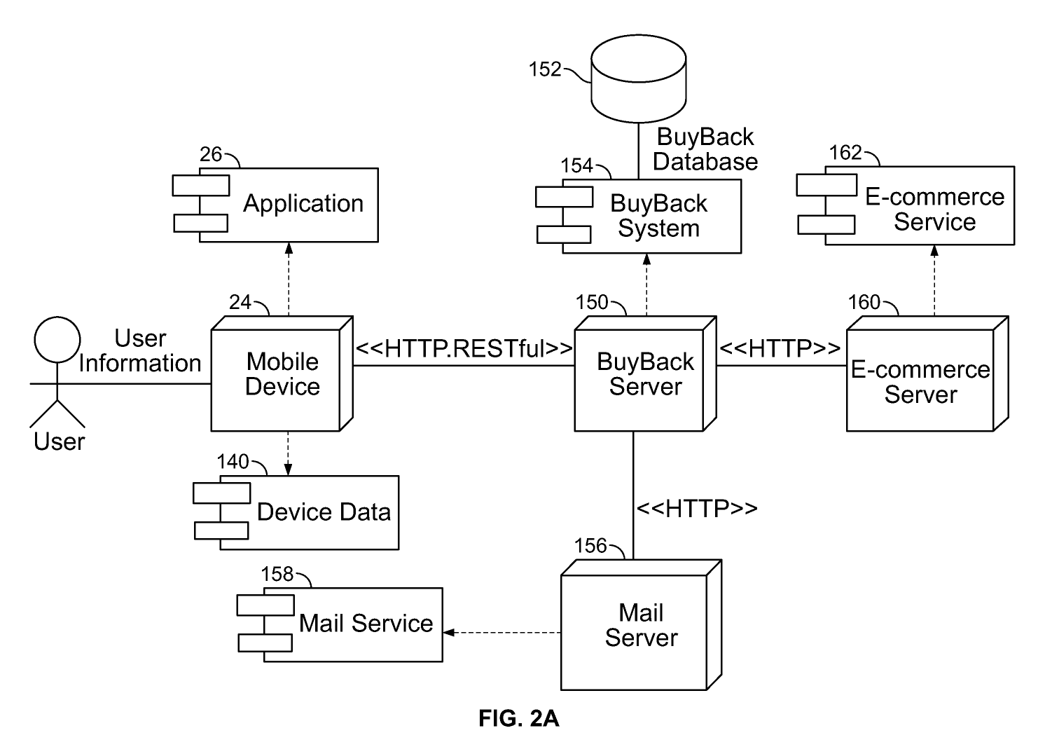

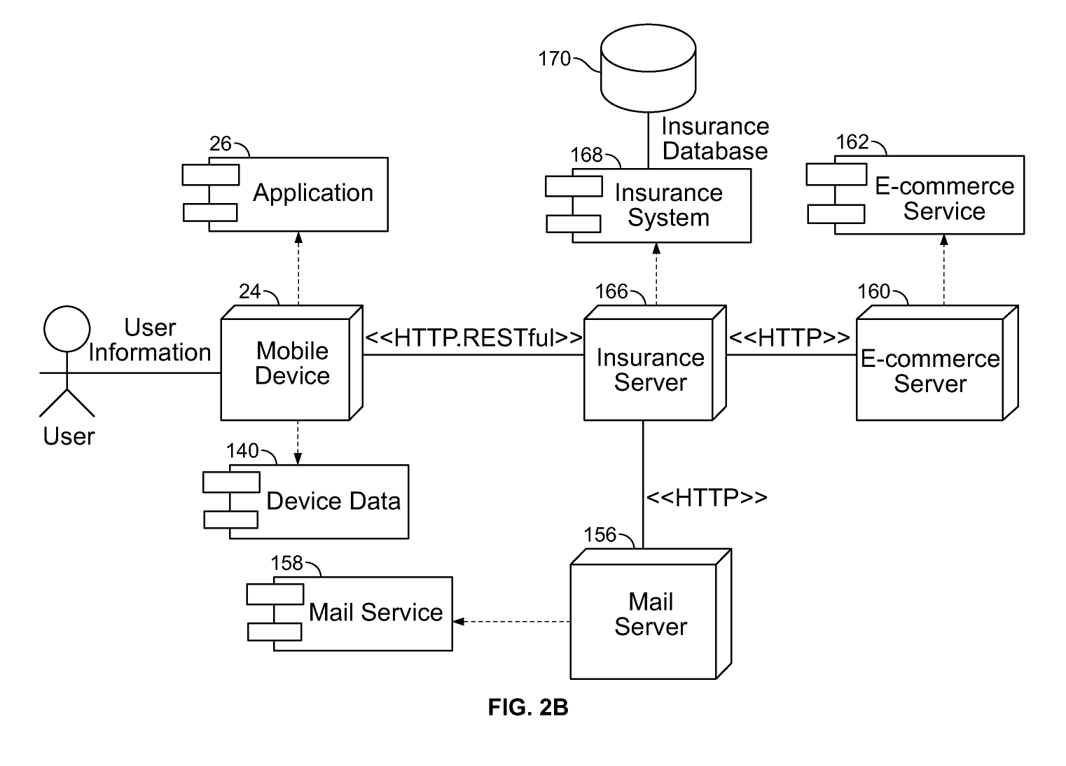

Back-end system architecture for an exemplary buy-back module 16 is depicted in FIG. 2A and back-end system architecture for an exemplary insurance module 18 is depicted in FIG. 2B. While the architecture of FIGS. 2A and 2B will be described with respect to the buy-back module 16 and insurance module 18, such architecture may be similar for any of the modules. As noted above, each mobile device 24 includes thereon an application 26, which has been downloaded in some fashion onto the mobile device 24. Each mobile device 24 also includes data 140 that is stored thereon, for example, a mobile device type/manufacturer, model number, user information, and/or any other suitable data. As seen in FIG. 2A, the application 26 communicates through the wireless communication device of the mobile device with a buy-back server 150. The buy-back server 150, when prompted to do so by the application 26, may pull data from the mobile device 24, such as the mobile device type/manufacturer, mobile device model number, etc., and determines the real-time quotes to be provided to the user based on different payment types from a buy-back database 152, as will be discussed in greater detail below. Alternatively, the application 26 may pull the appropriate data and forward the data to the buy-back server 150. The buy-back server 150 sends the applicable quote information to the application 26 to be displayed on the mobile device 24 and for the user to select a desired payment type. The buy-back server 150 also communicates with the buy-back database 152 through a buy-back system 154 to save information on the transaction to the buy-back database 152 once the buy-back process is complete.

The buy-back server 150 also communicates with a mail server 156 that generates confirmation emails to be sent to users as part of the buy-back process. The mail server 156 may forward the appropriate emails to a mail service 158 for forwarding to users. The emails may include, for example, information of the executed and completed process, such as a buy-back transaction identification, a buy-back payment, and/or any other suitable information.

During verification processes, the buy-back server 150 may also communicate with an e-commerce server 160 to verify in real-time information received from the user, for example, bank account information, address information, PayPal account information, and/or any other information that may need to be validated. The e-commerce server 160 communicates with one or more e-commerce services 162 that allow the relevant information to be verified in real-time, as the buy-back process is executed.

In a similar manner, as seen in FIG. 2B, the application 26 communicates through the wireless communication device of the mobile device with an insurance server 166. The insurance server 166 pulls data from the mobile device 24, such as the mobile device type/manufacturer, mobile device model number, state of residence of user, etc., and identifies available insurance plans for the mobile device-state combination and provides real-time quotes for those plans. Alternatively, the application 16 may pull the applicable data and forward the data to the insurance server 166 for processing. If the user selects to purchase insurance, the insurance server 166 also creates and saves user account information within an insurance database 170 for post-insurance transactions. The insurance process will be discussed in greater detail below.

Similar to the buy-back server 150 of FIG. 2A, the insurance server 170 of FIG. 2B communicates with the mail server 156, which generates emails, as discussed in more detail above, to be forwarded to the user as part of the insurance purchase process. Further, during a verification process, the insurance server 170 communicates with the e-commerce server 160 to verify information received from the user, for example, bank account information, address information, PayPal account information, and/or any other information that may need to be validated. The e-commerce serves 160 communicates with one or more e-commerce services 162 that allow the relevant information to be verified in real-time, as the insurance purchase process is being executed.

The servers discussed in relation to FIGS. 2A and 2B herein may be any suitable server or set of servers including, for example, Intel based servers, IBM® operating system servers, Linux operating system servers, Windows NT™ servers, Sybase, and/or any other suitable servers. The databases discloses herein may be any suitable database or set of databases.

In order to access the systems and methods of the present disclosure, a user may download the application 26, for example, from any suitable marketplace selling mobile device applications, Over the Air (OTA), through the Internet, or by any other suitable means. Optionally, the application 26 may be pre-downloaded onto the mobile device 24 and already included on the mobile device at the point-of-purchase. The application 26, upon launch on the mobile device 24, may allow the user to log into the application 26 and may thereafter allow the user to select from one or more modules 16, 18, 19, 20, 21, 22, such as one or more of the modules noted above.

In an illustrative embodiment, as seen in FIG. 1, the application 26 includes modules, such as, a buy-back module 16, an insurance module 18, a locate/restore module 19, a leasing or purchase module 20, a customer service module 21, and any other suitable modules 22. Upon start-up of the application 26 for the first time, the application 26 may require a user to set up an account and associate that account with their services provider account (e.g., Sprint, AT&T, T-Mobile, Cricket, etc.). Once a user is logged into the application 26, the user may select to initiate processes for any of the modules. While a plurality of modules are depicted, any number of modules may be accessible to a user. In illustrative embodiments, depending on the user, their preferences, their carrier, the plan, or any other factors, one or more of the modules may be selectively deactivated in that a user may not be able to access such modules. In other illustrative embodiments, a user may be able to access any of the available modules.

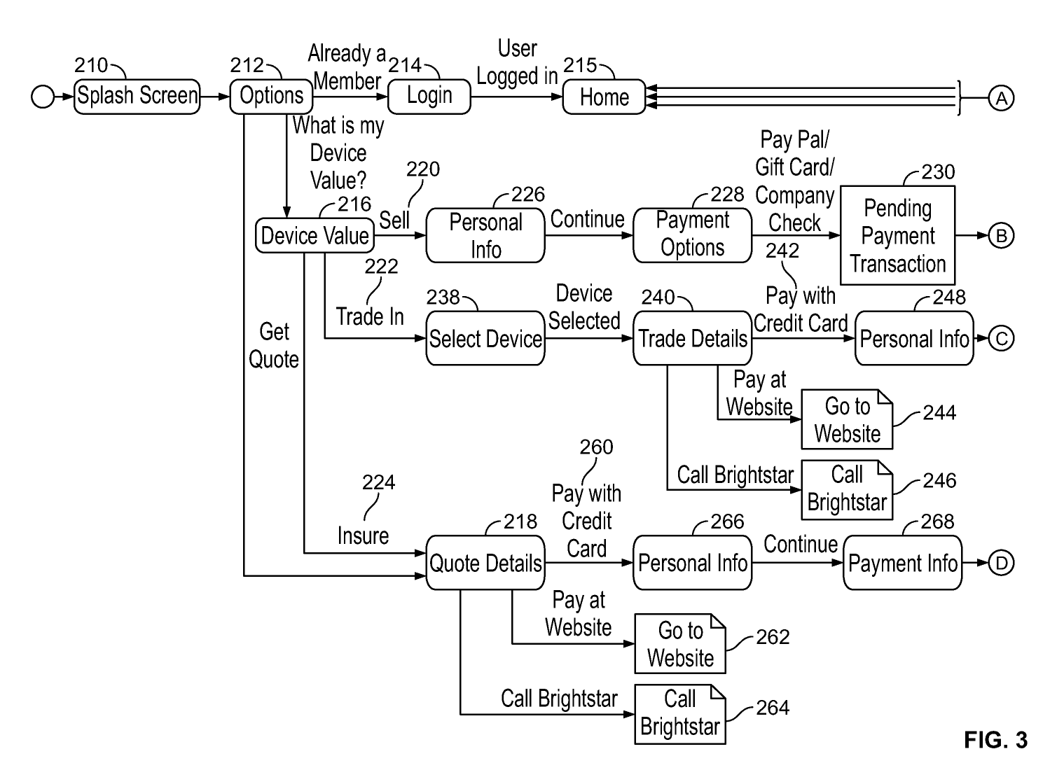

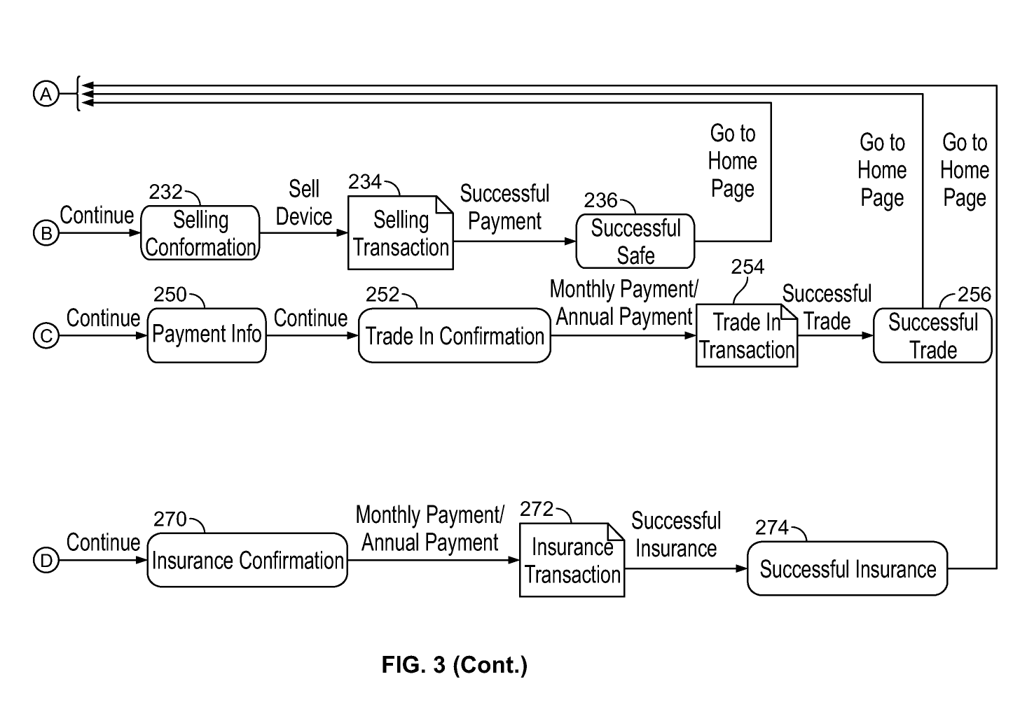

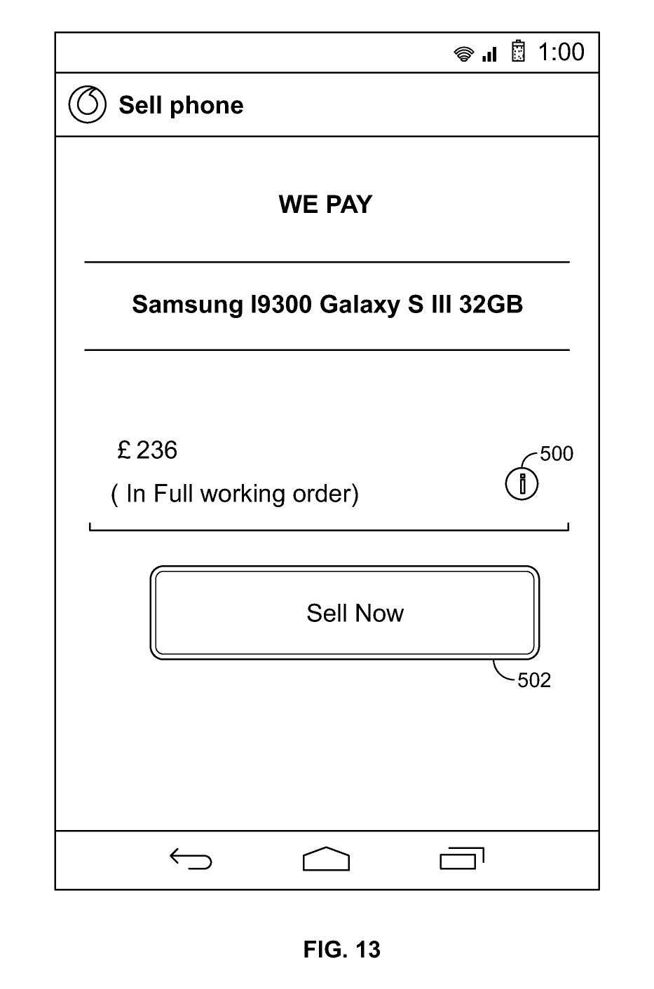

A high-level overview of the process flow of the various processes employed by the modules of the application 26 of the present disclosure is depicted in FIG. 3. Upon start-up of the application 26 on a mobile device 24, a welcome or splash screen 210 may be displayed. A number of options 212 are presented to the user, for example, login 214, device value 216, and quote details 218. If a user is already a member, the user can login at 214, wherein a home screen 215 will be displayed on the user interface. The home screen 215 may allow the user to access any number of modules, the functionality of which will be described in detail below. The user may select device value 216 without logging in to initiate a mobile device sale 220, a buy-back 222, or purchase insurance 224. If the user selects to obtain their real-time mobile device value 216 and proceeds through the path to sell the mobile device 220, the application 26 generally requests personal information 226, provides for payment 228, processes payment 230, confirms sale 232, completes the sale 234, and provides confirmation of a successful sale 236. After a sale is complete, a user will be forwarded to the home screen 215. The sale process will be discussed in great detail below with respect to FIGS. 13-15.

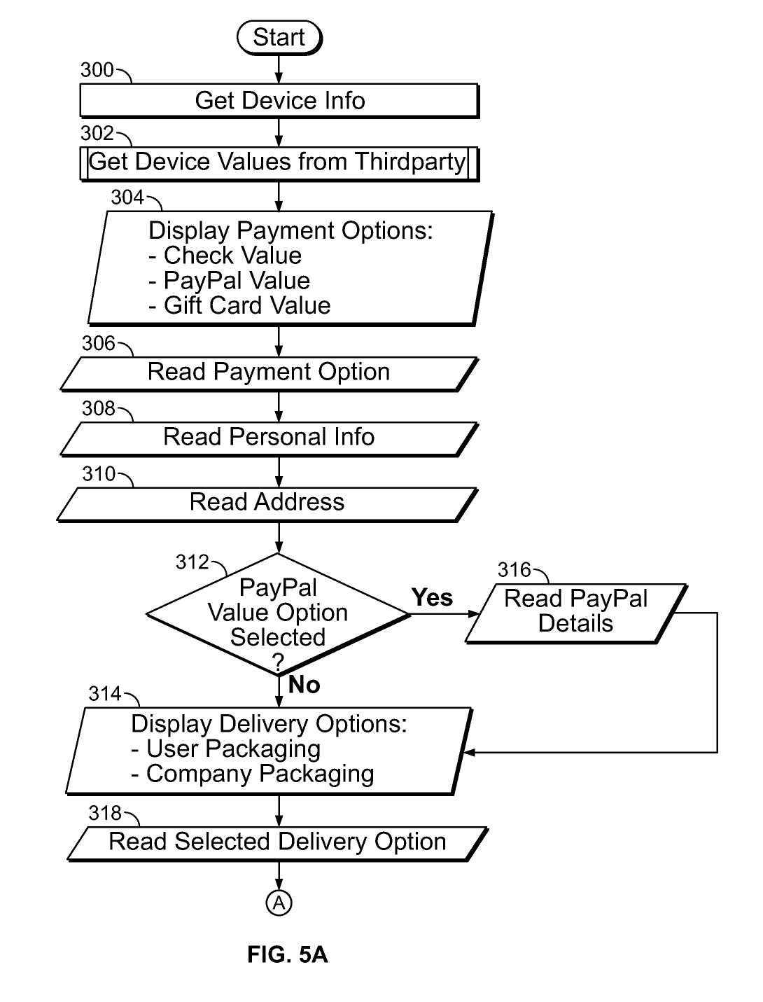

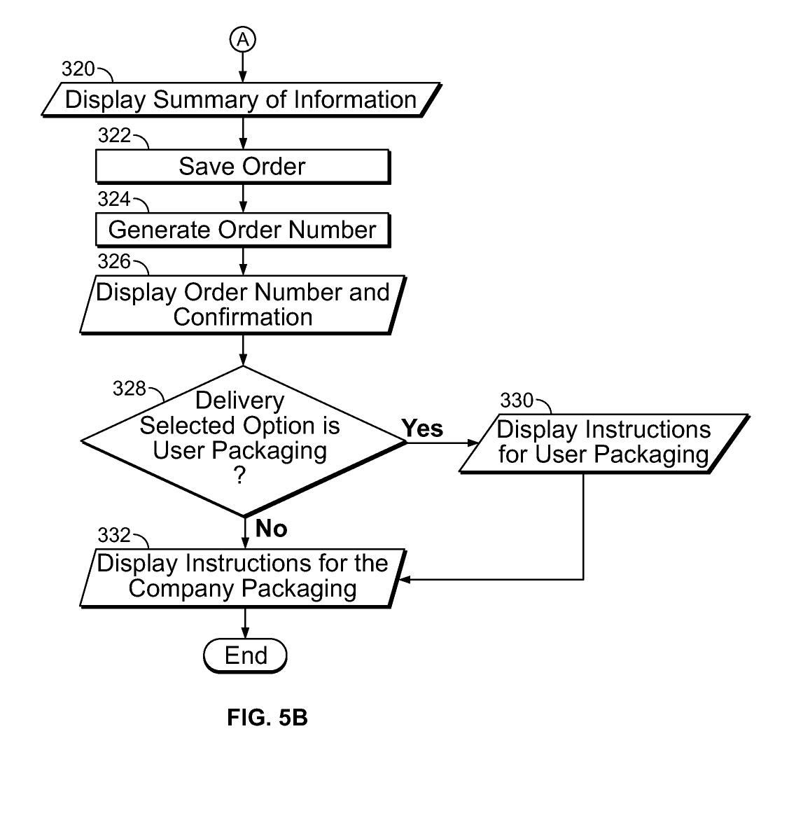

Still referring to FIG. 3, if a user selects to obtain their real-time mobile device value 216 and proceeds through the path to trade-in their mobile device 222, the application 26 generally prompts the user for information about their mobile device 238 and details about the trade-in 240. After inputting the requested information, the user may choose to proceed with payment through the application 242 or may optionally be linked to a website 244 to pay or have the option of calling customer service 246 to pay. If the user selects to pay through the application 26, the application 26 requests personal information from the user 248, requests payment information from the user 250, confirms the trade-in 252, processes the trade-in 254, and provides confirmation of a successful trade-in 256. After a trade-in is complete, a user may be forwarded to the home screen 215. The trade-in process will be discussed in greater detail below with respect to FIGS. 5A-9.

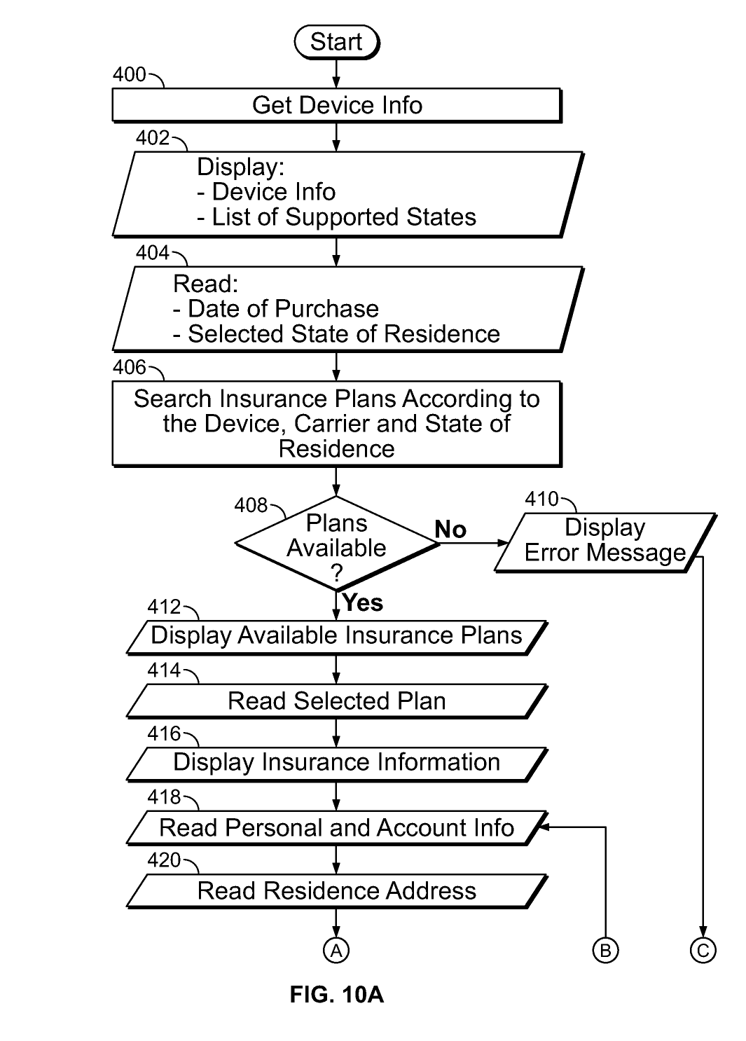

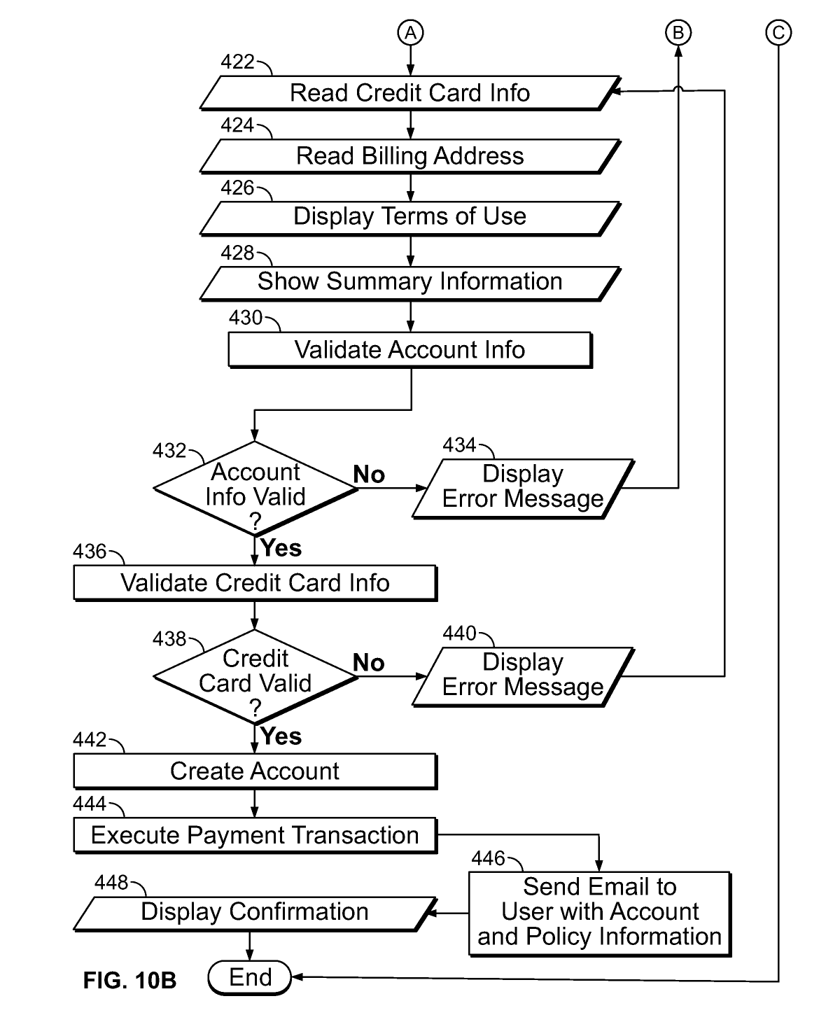

If a user selects to obtain a real-time quote for the purchase of insurance, as seen in FIG. 3, the application 26 proceeds through the path to insure their mobile device 224. Once a quote is obtained and selected, the user may finish the purchase of insurance through the application 260 or may optionally be linked to a website 262 for purchase of insurance or have the option of calling customer service 264 to purchase the insurance based on the quote. If the user selects to purchase insurance through the application 26, the application 26 requests personal information from the user 266, requests payment information from the user 268, confirms the insurance information 270, processes the purchase of insurance 272, and provides confirmation of successful purchase of insurance 274. After purchase of insurance is complete, a user may be forwarded to the home screen 215. The insurance purchase process will be discussed in greater detail below with respect to FIGS. 10A-12.

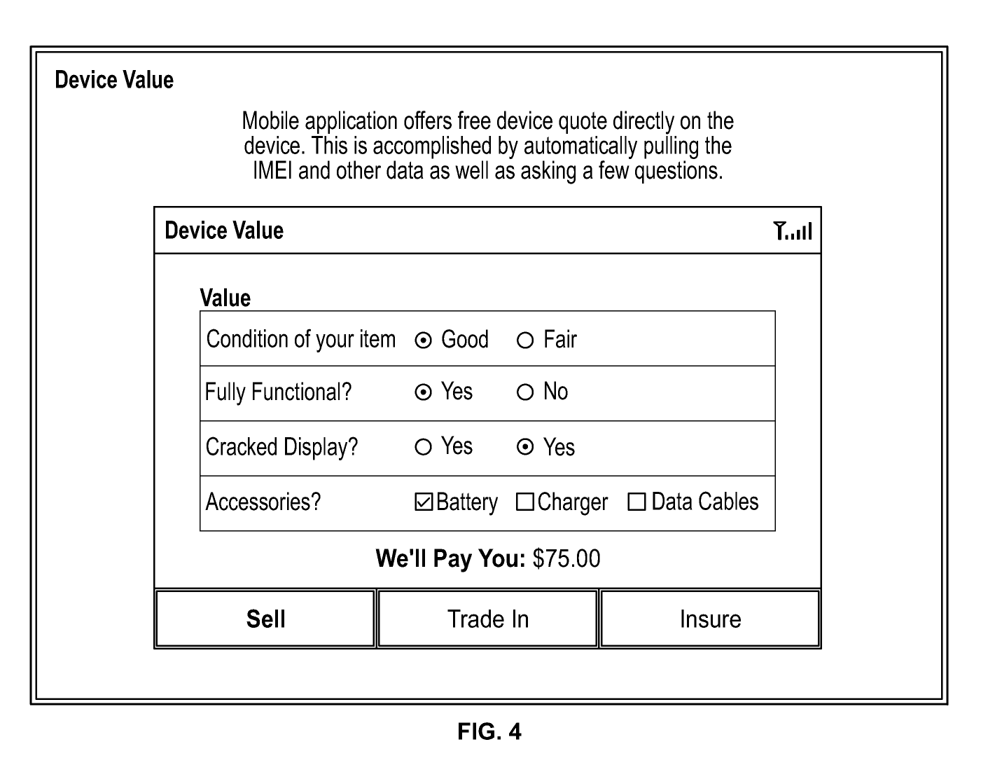

As noted above, a user may use the application 26 to determine a real-time value for their mobile device, for example, for purposes of trade-in, sale, insurance, or leasing. As seen in FIG. 4, after selecting to obtain a real-time device value or selecting a relevant module, the user may be prompted to answer a number of different questions regarding the condition of their mobile device 24, for example, the user may be prompted to indicate a condition of the mobile device 24 (i.e., good or fair), whether the mobile device 24 is fully functioning (i.e., yes or no), whether the display is cracked (i.e., yes or no), and/or whether the calculated value should include any number of different accessories (i.e., battery, charger, data cables, etc.). The user may also be prompted to select whether they wish to sell, trade-in, or insure their mobile device 24. Once the user has entered the appropriate information, the application determines in real-time a value for the mobile device 24. The value is provided in real-time and may be determined by accessing current value data contained in a database, value data provided by third parties, value data found in real-time on the Internet, or value data found in any other suitable source.

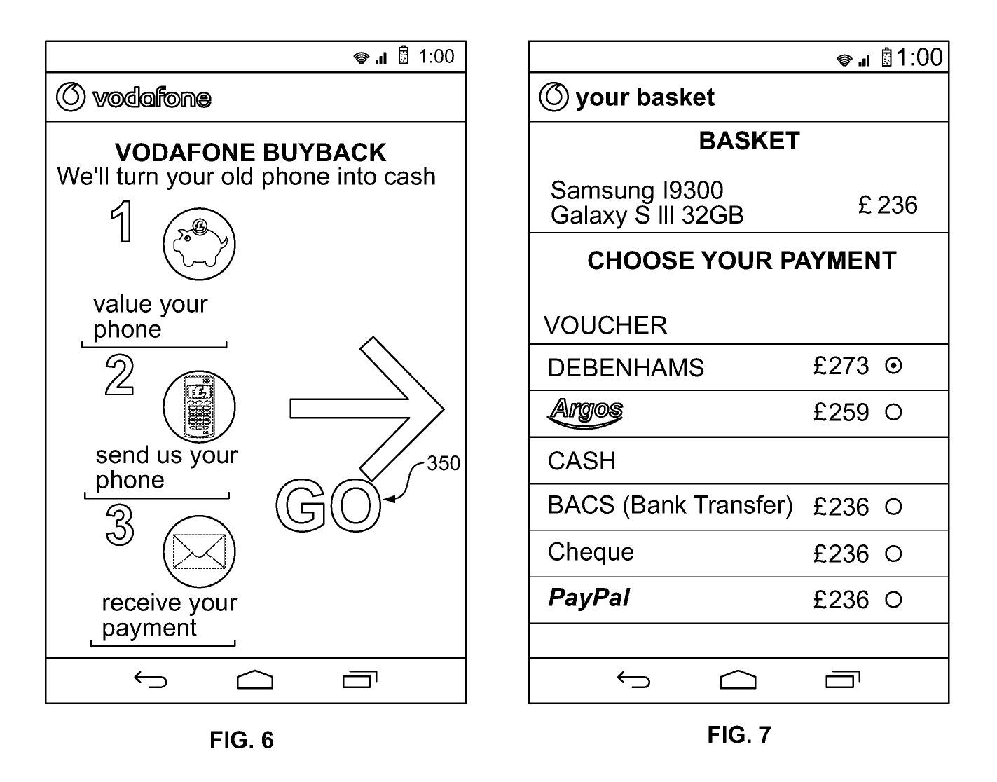

Referring to FIGS. 5A, 5B, 6, 7, 8A, 8B, 9, and 13-15 a flow chart depicting exemplary functionality of a buy-back or trade-in process conducted through the buy-back module 202 (FIG. 5A and 5B) and a number of screens (FIGS. 6-9 and 13-15) encountered by a user on the mobile device user interface and showing the progression of the buy-back process are shown. In illustrative embodiments, the buy-back module 202 allows a user to trade-in or sell their mobile device in exchange for payment. Upon selection of the buy-back module 202 in the application 26, a screen such as that shown in FIG. 6 is seen by the user on their mobile device user interface. After the user selects the “GO” button 350 in FIG. 6, the application 26 (or a buy-back server 150) accesses the mobile device 24 to determine information regarding the mobile device 24 at block 300. The application 26 may pull information such as, for example, user name, mobile device type/manufacturer and/or model, international mobile equipment identity number, telephone number, if applicable, carrier, email, address, date of purchase, age of mobile device, and/or any other suitable information. The application 26 then forwards the information to a third party and/or the buy-back server 150 at block 302 that uses the information to assess a real-time value of the user's used mobile device 24.

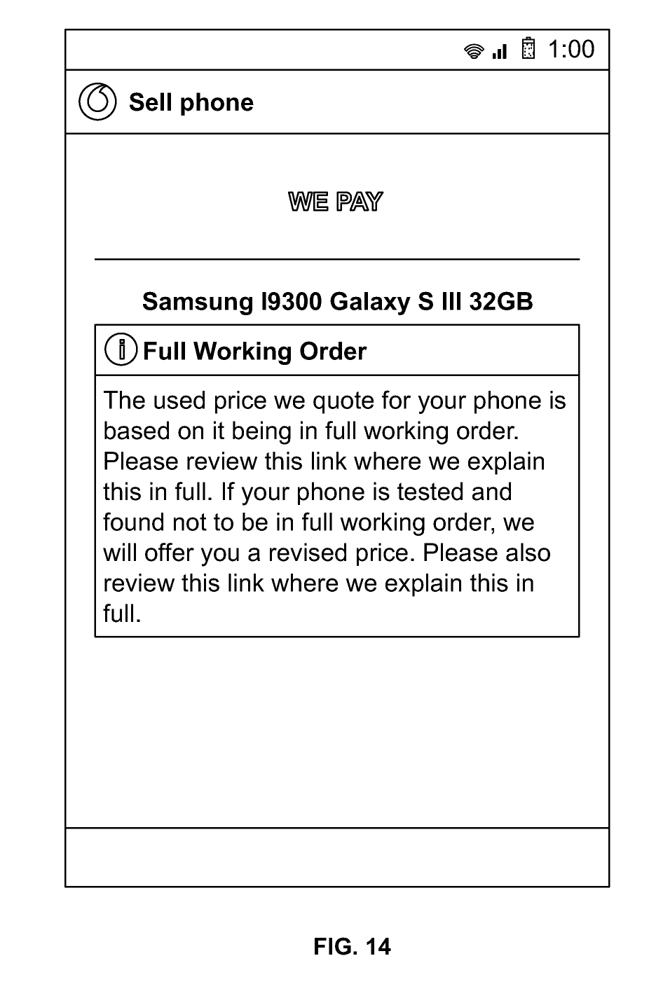

The real-time value returned by the third party and/or the buy-back server 150 may then be displayed on the mobile device 24 in real-time, for example, in the form of a check value, a PayPal value, a gift card value, or any other suitable value at block 304, a seen in the screen of FIG. 13. The pricing is provided in real-time and may be determined by accessing current pricing data contained in a database, pricing data provided by third parties, pricing data found in real-time on the Internet, or pricing data found in any other suitable source. Referring to FIG. 13, the user may click on an information icon 500, which may present a warning to the user, for example, as seen in FIG. 14. If the user desires to proceed with sale of their mobile device 24, the “Sell Now” button 502 may be clicked, wherein a number of different payment options and values may be presented, as seen in FIG. 7.

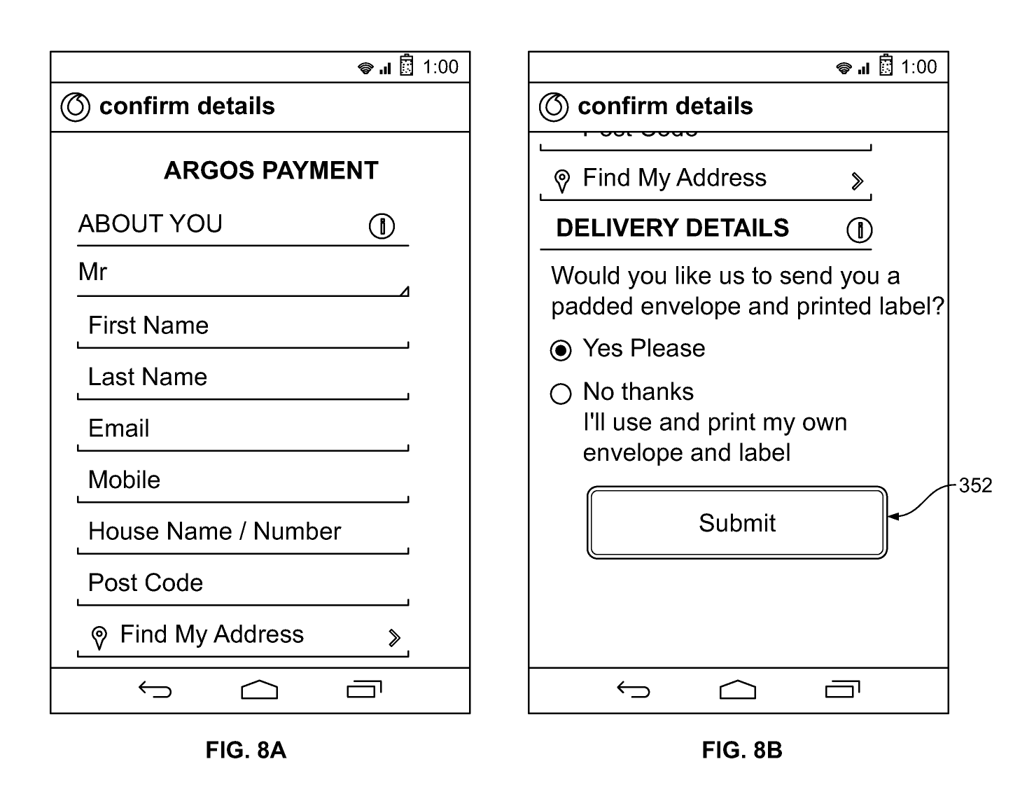

Once the values are presented in FIG. 7, the user may be asked to select how they want payment, for example, via check, PayPal, or gift card, and the details for payment (e.g., name, address, phone number, etc.). The values and types of payments may be displayed for selection by the user, for example, as seen in FIGS. 8A and 8B. Once a selection is made, the user may be required to select a “continue” or “next” button” (not shown) to proceed through the buy-back process. The selected payment option is read at block 306 of FIG. 5A and the application 26 proceeds to a screen that either displays known user information (which may be pulled from the mobile device 24) or requires the user to input personal information, as seen in FIGS. 8A and 8B. Once the user submits the relevant information (FIG. 8B), the submitted information is read by the application 26 at block 308 of FIG. 5A and the address of the user may be read by the application 26 at block 310 of FIG. 5A. At block 312 of FIG. 5A, the application 26 determines whether the PayPal payment option was selected. If the application 26 determines that the PayPal payment was not selected, processing proceeds to block 314, wherein the user may be required to select whether they have their own envelope and label or whether they would like an envelope and label sent to them for return of the mobile device 24 for buy-back, as seen in the user interface of FIG. 8A. If the application 26 determines that PayPal payment was selected, processing proceeds to block 316 where the PayPal details are read by the application 26 and processing proceeds to block 314. Once the details in FIGS. 8A and 8B have been input, a user may select the “Submit” button 354.

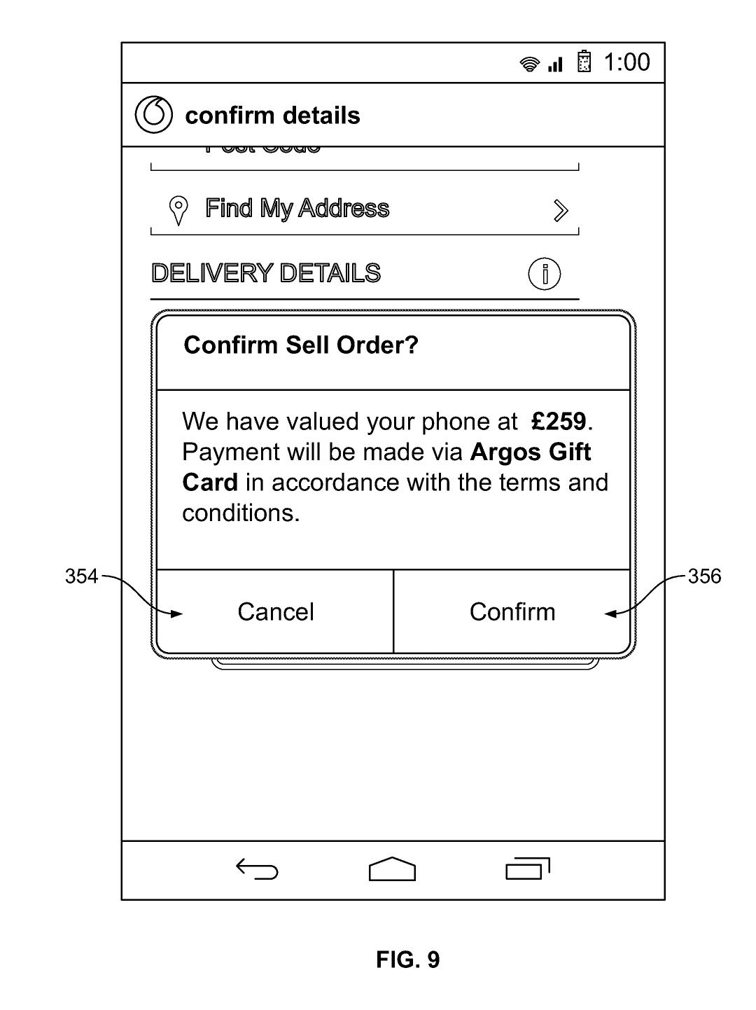

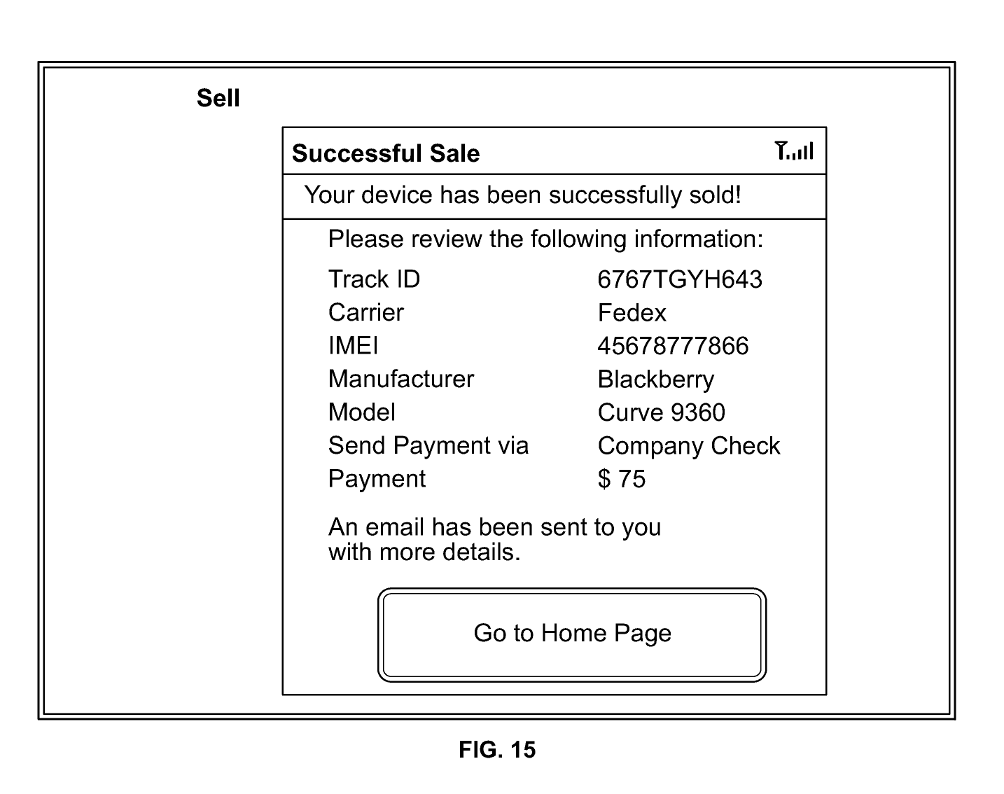

Once the information of FIGS. 8A and 8B has been submitted, the application 26 reads the selected delivery option (from FIG. 8B) at block 318 and a summary and confirmation of the buy-back information is displayed in a user interface at block 320, as seen in FIG. 9. The summary and confirmation screen of FIG. 9 may include any number of transaction details, for example, the mobile device value, buy-back value, the type of payment, and any other suitable information. The user may then be prompted to select a “cancel” button 354 to cancel the transaction or a “confirm” button 356 to confirm and submit the transaction. Once the “confirm” button 356 has been selected, the application 26 saves the order at block 322 of FIG. 5B and generates an order number at block 324 of FIG. 5B. The order number and a confirmation number may then be displayed on the mobile device user interface at block 326, as seen in FIG. 15. Any relevant sale details may be included in the confirmation, for example, carrier, IMEI number, manufacturer, model number, payment method, payment amount, and any other suitable information.

Referring again to FIG. 5B, if at block 328, the application 26 determines that the user selected to use their own packaging, instructions for forwarding the mobile device 24 in user packaging are displayed at block 330. Alternatively, if at block 328, the application 26 determines that the user selected to be sent packaging, instructions for obtaining packaging and/or forwarding the mobile device 24 in company packaging are displayed at block 332.

While a particular type of payment is depicted in FIGS. 8A, 8B, and 9, payment may be made to the user in any suitable form and may work in the same or similar manner as that depicted in FIGS. 8A, 8B, and 9 and described with respect thereto. As noted above, payment may be made by check, PayPal account, gift card, or any other suitable payment type. Alternatively, the appropriate funds may be transferred directly to a savings or checking account of the user, or may be applied against an account of the user (e.g., the carrier account of the user).

During the buy-back process and other processes implemented by the buy-back module 16, some or all portions of the processes described as implemented by the application 26 may be completed by the servers 150, 156, 160 and/or other components described above with respect to FIG. 2A. All or portions of any of the processes implemented by the application 26 may be performed on the mobile device 24 or remotely by servers or other components.

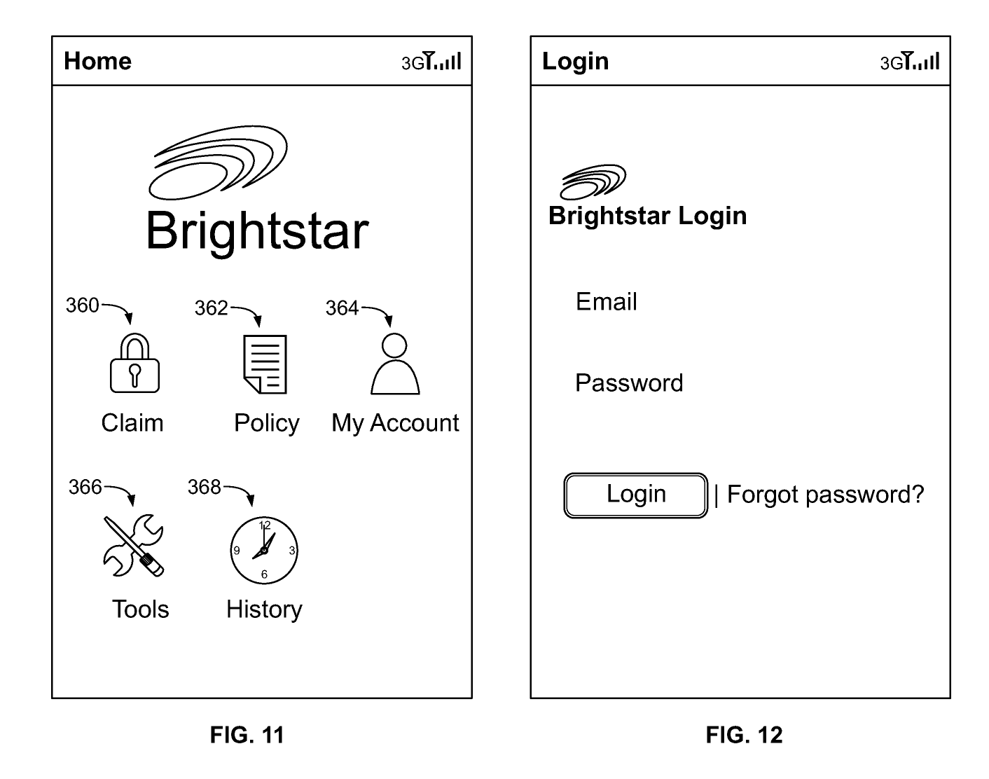

FIGS. 10A, 10B, 11, and 11 show a flow chart depicting exemplary functionality of an insurance purchase process implemented by the insurance module 204 (FIGS. 10A and 10B) and a number of screens encountered by a user on their mobile device user interface during the insurance purchase process (FIGS. 11 and 12). As seen in FIG. 11, the insurance module 202 provides a number of different features and functions, for example, submission of an insurance claim 360, viewing or purchasing a policy 362, viewing account details 364, use of various insurance-related tools 366, viewing insurance (e.g., purchase, claim, etc.) history, and/or any other suitable features or functions. An illustrative embodiment of the purchase of an insurance policy is depicted in FIGS. 10A and 10B. Upon selection of the icon 362 for viewing or purchasing a policy, a user may be asked to log in, as seen in FIG. 12. Whether or not the user is asked to log in, the application 26 (and/or the buy-back server 15) accesses the mobile device 24 to pull information regarding the mobile device 24 at block 400. The application 26 may pull information such as, for example, user name, mobile device type/manufacturer and/or model, international mobile equipment identity number, telephone number, if applicable, carrier, email, address, date of purchase, age of mobile device, and/or any other suitable information. The application 26 may, thereafter, display the device information, user information, and/or a list of states in which insurance is supported at block 402. The user may be then required to select a state of residence for insurance coverage.

Still referring to FIG. 10A, at block 404, the application 26 may read the date of purchase from the mobile device 24 and/or may retrieve such information from the carrier or the user and the application 26 will further read the selected state of residence. The application 26 may then search insurance plans based on the type or model of the mobile device, the carrier, and the state of residence at block 406. The application 26 then determines at block 408 whether any insurance plans are available. As part of the insurance purchase process, the application 26 may also, as described above, determine a real-time value for the mobile device 24, which is a factor used in determining the price for insurance and/or potential plans. If, at block 410, the application 26 determines that no insurance plans are available, the process of FIGS. 10A and 10B is terminated and the user may be notified that no insurance plans are available. If, at block 410, the application 26 determines that insurance plans are available, the process proceeds to block 412, wherein the available insurance plans are displayed on the mobile device user interface. The user is then prompted to select an available insurance plan and the application 26 reads the selected plan at block 414.

As seen in FIG. 10A, insurance information for the selected insurance plan may be displayed at block 416. The user may thereafter be prompted to enter personal information, such as, for example, name, residence address, credit card information, billing address, and other suitable information, for purchase of the insurance plan. The residence address, credit card information and billing address may thereafter be read by the application 26 at blocks 420, 422, 424, respectively. Alternatively or additionally, any information may be required of the user and/or may be read by the application 26 (or the buy-back server 15). After the user personal information is read, the terms of use for the insurance plan are displayed on the mobile device user interface for viewing by the user at block 426 and a summary of the personal information submitted by the user is displayed on the same or a different screen on the mobile device user interface at block 428. Thereafter, the application 26 may send the user information for validation at block 430. The application 26 may check at block 432 whether the account information entered by the user is valid. If the account information is determined not to be valid at block 432, the process proceeds to block 434, wherein an error message is displayed. The process may completely terminate or processing may proceed back to block 418, wherein the user is again prompted to input correct account information for reading by the application 26.

If, at block 432, the application 26 determines that the account information is valid, the process proceeds to block 436, wherein the user credit card information is validated. If, at block 438, the credit card information is determined to not be valid, processing proceeds to block 440. At block 440, an error message may be displayed and the process may be completely terminated or processing may proceed back to block 422 to prompt the user to input accurate credit card information for reading by the application 26. The application 26 may also validate additional information, for example, the application 26 may verify the submitted data against a carrier database to verify that the mobile device 24 has not been lost or stolen.

If, at block 432, the application 26 determines that the entered credit card information is valid, the process proceeds to block 442, wherein an account is created for the user. Thereafter, the payment transaction is executed at block 444 and an email containing the account and insurance plan information is forwarded to the user at block 446. Optionally or additionally, the account and insurance plan information may be forward by mail or any other suitable method. A confirmation is thereafter displayed on the mobile device user interface at block 448 to confirm that the transaction has successfully concluded.

During the insurance purchase process and other processes implemented by the insurance module 18, some or all portions of the processes described as implemented by the application 26 may be completed by the servers 156, 160, 166 and/or other components described above with respect to FIG. 2B. All or portions of any of the processes implemented by the application 26 may be performed on the mobile device 24 or remotely by servers or other components.

The locate/restore module 19 is a value added service that provides data protection and recovery. In illustrative embodiments, the locate/restore module 19 may provide one or more services to a user, for example, locating of a mobile device using, for example GPS or cell tower tracking, providing backup and restoration for lost data or information on the mobile device, device unlocking (SMS or web unlock), and/or remote or automatic locking of the mobile device. The remote or automatic locking may provide a full screen lock, a SIM change lock (i.e., the device locks if the SIM card is changed), an SMS lock (i.e., the use of another device to remotely send SMS to lock the device), or any other suitable locking feature.

The customer support module 21 may provide access to direct customer support through the user's mobile device 24. While the customer support module 21 may implement any features or functions related to customer support, illustrative customer support features include call center access, call center call back, self-service, diagnostics, and/or any other suitable customer service features.

Any number of the modules disclosed herein, for example, the buy-back/trade-in module 16 and/or the insurance module 18, may benefit from remote diagnostics. The application 16, the platform 12, and/or relevant modules may include programming to diagnose any potential issues with a mobile device 24. In an illustrative embodiment, in a situation where a user is opting to purchase insurance (or trade-in a mobile device), it may be desirous to determine whether the mobile device 24 is currently broken, not working properly, or otherwise in immediate need of insurance. In an illustrative embodiment, the user may be prompted to take and upload a photograph of the mobile device 24 to determine whether the mobile device 24 is broken, banged up, or otherwise in need of repair. In other illustrative embodiments, the user may be prompted to swipe their finger across the screen, in which case, the application 26 may be capable of determining a jagged or non-straight swipe path, a change in swipe speed or path, or any other uncharacteristic or atypical swipe characteristic that may be indicative of a broken or otherwise damaged screen. In illustrative embodiments, the user may be given one or more swipe patterns to follow and the system may use such swipe patterns to detect irregularities. In illustrative embodiments, the mobile device 24 may include a resistive system, a capacitive system, a surface acoustic wave system, or any other suitable system for detecting, translating, and/or analyzing a swipe pattern of a user. Still further, in illustrative embodiments, the application 26 may be capable of testing a mobile communication (e.g., WiFi or Bluetooth) signal, battery functionality, or the proper functioning of any components or applications of the mobile device.

While some features and functions are discussed in detail for some of the modules discussed herein, each of the modules may also include other features and functions related to the respective modules. In an illustrative embodiment, the insurance module may additionally allow a user to view, cancel, or modify their insurance policy, file a claim, seek support, view frequently asked questions, and/or access or modify any features of their insurance plan. In another illustrative embodiment, the buy-back/trade-in module may additionally allow a user to view the status of a buy-back/trade-in, save and access quotes for buy-back/trade-in, and/or may provide any other suitable features or functionality.

The systems and methods disclosed herein provide a single point for a user to monitor, manage, and access information regarding their mobile device. Namely, a user may access the application 26, which allows the user to control various aspects of their mobile device from a single entry point. The systems and methods disclosed herein provide a central location for management of one's mobile device without the need to visit multiple Internet websites or download multiple device applications. The user experience is streamlined and time is saved.

While the steps of the methods disclosed herein are depicted and described as being in a certain sequence, one skilled in the art will understand that some of the method steps herein may be removed, modified, and/or the order thereof may be changed without departing from the scope of the present application.

Numerous modifications to the present disclosure will be apparent to those skilled in the art in view of the foregoing description. Accordingly, this description is to be construed as illustrative only and is presented for the purpose of enabling those skilled in the art to make and use the embodiments of the disclosure and to teach the best mode of carrying out same. The exclusive rights to all modifications which come within the scope of the appended claims are reserved.

We claim:

1. A method of managing mobile device lifecycle, the method comprising the steps of:
providing a first module accessible through an application residing on a mobile device, whereby upon selection by a user of the mobile device of an insurance purchase transaction, the application initiates a transaction for the purchase of insurance for the mobile device: and
providing a second module accessible through the application residing on the mobile device, whereby upon selection by a user of the mobile device of a sale transaction, the application initiates a transaction for the sale of the mobile device.

2. The method of claim 1, wherein, after initiation of a transaction for the purchase of insurance for the mobile device, the application performs the steps of:
retrieving data from the mobile device including a mobile device make and a mobile device model;
prompting the user for a state of residence;
reading the state of residence after input by the user;
determining, based on the mobile device make and model and user state of residence, whether one or more insurance plans are available for the mobile device and, if one or more insurance plans are available for the mobile device, presenting the available plans on the mobile device and, if no insurance plans are available for the mobile device, indicating that no insurance plans are available; and
allowing the user of the mobile device to purchase an insurance plan from the mobile device if one or more insurance plans are available.

3. The method of claim 1, wherein, after initiation of a transaction for the sale of the mobile device, the application performs the steps of:
retrieving data from the mobile device including a mobile device make and a mobile device model;
retrieving values for the mobile device based on the mobile device make and model;
presenting different values for the mobile device on the mobile device, wherein the values may differ dependent upon a method of payment to the user;
collecting personal information from the user; and
completing a sale of the mobile device.

4. The method of claim 1, wherein a real-time value for the mobile device is determined by performing the steps of:
retrieving data from the mobile device including a mobile device make and a mobile device model;
assessing a condition of the mobile device by performing at least one of the following steps:
prompting the user to enter information about the mobile device; and
remotely running one or more tests through the application to determine a condition of the mobile device; and
determining a real-time value for the mobile device.

5. The method of claim 4, wherein the step of remotely running one or more tests includes the steps of:
prompting the user to move their finger across a screen of the mobile device; and
sensing whether the movement has an atypical characteristic.

6. The method of claim 2, wherein, after initiation of a transaction for the sale of the mobile device, the application performs the steps of:
retrieving data from the mobile device including a mobile device make and a mobile device model;
retrieving values for the mobile device based on the mobile device make and model;
presenting different values for the mobile device on the mobile device, wherein the values may differ dependent upon a method of payment to the user;
collecting personal information from the user; and
completing a sale of the mobile device.

7. The method of claim 4, further including the steps of
providing a third module in an application residing on a mobile device, whereby upon selection by a user of the mobile device of a locate or restore operation, the application initiates an operation comprising at least one of the following steps:
locating the mobile device by GPS or tower tracking;
restoring default settings of the mobile device; and
locking at least one function of the mobile device.

8. The method of claim 7, wherein the step of locking at least one function of the mobile device is selected from the group consisting of: a full screen lock, a SIM change lock, an SMS lock.

9. A computerized system for managing mobile device lifecycle, the system comprising:
a mobile device insurance module on a computer configured to provide real-time insurance policy quotes based on a real-time mobile device value and allow a mobile device user to purchase an insurance policy, wherein the insurance module receives data from the mobile device including the mobile device manufacturer and model; and
a mobile device buy-back module on a computer configured to provide a real-time quote for purchase of the mobile device based on the real-time mobile device value and allow a mobile device user to sell their mobile device, wherein the buy-back module receives data from the mobile device including the mobile device manufacturer and model.

10. The computerized system of claim 9, wherein the insurance module is further configured to allow a current customer with an insurance policy to view, modify, or cancel their insurance policy.

11. The computerized system of claim 9, wherein at least one of the insurance and buy-back modules is configured to assess a condition of the mobile device.

12. A computerized system comprising:
one or more computing devices including:
a memory having program code stored therein;
a processor in communication with the memory for carrying out instructions in accordance with the stored program code, wherein the program code, when executed by the processor, causes the processor to perform the operations comprising:
allowing selection of an insurance module on a mobile device, wherein the insurance module is configured to allow a mobile device user to purchase insurance utilizing the insurance module; and
allowing selection of a buy-back module on a mobile device, wherein the buy-back module is configured to allow a mobile device user to access a quote for trade-in their mobile device and allow the mobile device user to trade-in their mobile device.

13. The computerized system of claim 12, wherein the operations comprise, after initiating a transaction for the purchase of insurance:
retrieving data from the mobile device including a mobile device make and a mobile device model;
prompting the user for a state of residence;
reading the state of residence after input by the user;
determining, based on the mobile device make and model and user state of residence, whether one or more insurance plans are available for the mobile device and, if one or more insurance plans are available for the mobile device, presenting the available plans on the mobile device and, if no insurance plans are available for the mobile device, indicating that no insurance plans are available; and
allowing the user of the mobile device to purchase an insurance plan from the mobile device if one or more insurance plans are available.

14. The computerized system of claim 12, wherein the operations comprise determining a real-time value for the mobile device by performing the steps of:
retrieving data from the mobile device including a mobile device make and a mobile device model;
assessing a condition of the mobile device by performing at least one of the following steps:
prompting the user to enter information about the mobile device; and
remotely running one or more tests through the application to determine a condition of the mobile device; and
determining a real-time value for the mobile device.

15. The computerized system of claim 14, wherein the step of remotely running one or more tests includes the steps of:
prompting the user to move their finger across a screen of the mobile device; and
sensing whether the movement has an atypical characteristic.

16. The computerized method of claim 13, wherein the operations comprise, after initiation of a transaction for the sale of the mobile device:
retrieving data from the mobile device including a mobile device make and a mobile device model;
retrieving values for the mobile device based on the mobile device make and model;
presenting different values for the mobile device on the mobile device, wherein the values may differ dependent upon a method of payment to the user;
collecting personal information from the user; and
completing a sale of the mobile device.

17. The computerized method of claim 12, wherein the operations further comprise:
providing a third module in an application residing on a mobile device, whereby upon selection by a user of the mobile device of a locate or restore operation, the application initiates an operation comprising at least one of the following steps:
locating the mobile device by GPS or tower tracking;
restoring default settings of the mobile device; and
locking at least one function of the mobile device.

18. The computerized method of claim 17, wherein the step of locking at least one function of the mobile device is selected from the group consisting of: a full screen lock, a SIM change lock, an SMS lock.
